(19) United States
(12) Patent Application Publication
(10) Pub. No.: US 2017/0296303 A1
(43) Pub. Date: Oct. 19, 2017

(54) DENTAL AND ORTHODONTIC SERVICES

(71) Applicant: KS FARMER & MA TOD DENTAL PTY LTD, Eltham, Victoria (AU)

(72) Inventors: Marcus Tod, Eltham, Victoria (AU); Kent Farmer, Eltham, Victoria (AU)

(21) Appl. No.: 15/510,192

(22) PCT Filed: Feb. 20, 2015
(86) PCT No.: PCT/AU2015/000092

§ 371 Date: Mar. 9, 2017

(30) Foreign Application Priority Data
Oct. 15, 2014 (AU) PCT/AU2014/050287

(51) Int. Cl. A61C 7/00; G06F 19/00; A61C 7/08; A61C 8/00

(52) U.S. Cl. CPC A61C 7/002; G06F 19/32; A61C 7/08; A61C 8/0093; G06F 19/345

(57) ABSTRACT

The present invention relates to a method for determining suitability of an orthodontic treatment. The method is implemented with at least one computational device and involves posing one or more queries relating to a potential patient. One or more answers to the queries are received and the suitability of the orthodontic treatment is determined based upon the received answers. Advantageously, the potential patient may conveniently perform a self-determination relating to the suitability of the orthodontic treatment prior to arranging a formal assessment with an orthodontist.

### TECHNICAL FIELD

The present invention generally relates to orthodontic treatments such as braces.

### BACKGROUND

The reference to any prior art in this specification is not, and should not be taken as an acknowledgement or any form of suggestion that the prior art forms part of the common general knowledge.

Orthodontics is a specialty of dentistry that is concerned with the study and treatment of malocclusions (improper bites), which may be a result of tooth irregularity or disproportionate jaw relationships.

A commonly used orthodontic treatment is dental braces whereby metal wires are inserted into orthodontic brackets, which can be made from stainless steel or a more aesthetic ceramic material. The wires interact with the brackets to move teeth into the desired positions. Other treatment methods may include aligners or retainers that move teeth.

The Applicant has noticed that some potential patients are inhibited from consulting with an orthodontist for an initial assessment. Furthermore, patients in remote locations are often not inclined to arrange the initial assessment for fear that the time and cost associated with arranging the assessment would be for nothing in the event that the treatment cost is beyond their means.

Embodiments of the present invention provide a means for quelling such assessment inhibitions of potential orthodontist patients.

### SUMMARY OF THE INVENTION

According to one aspect of the present invention, there is provided a method for determining suitability of an orthodontic treatment, the method including the steps of at least one computational device:
posing one or more queries relating to a potential patient;
receiving one or more answers to the queries; and
determining the suitability of the orthodontic treatment based upon the received answers.

Advantageously, the potential patient may conveniently perform a self determination relating to the suitability of the orthodontic treatment prior to arranging a formal assessment with an orthodontist.

The method may further include the step of capturing an image of the patient's teeth. The step of capturing may involve displaying a reference location or orientation for locating or orientating the teeth in the captured image. The method may further include the step of selecting a tooth of the captured image. The method may further include the step of associating a problem with the selected tooth. The problem may include a tooth sticking out, a crooked tooth or a gap between teeth.

The queries may relate to the type of bite of the patient, individual teeth of the patient. The answers may be selections to which weights are assigned.

The orthodontic treatment may be a reduced treatment, thereby encouraging those with limited means to seek treatment. The suitability may be a percentage determined using the assigned weights. The suitability may be displayed graphically and as being proportional to the simplicity of the patient's case.

The method may further include the step of providing a suitability report. The report may include the percentage. The report may further include a predicted treatment time, cost estimate of the treatment, and an indication of a suggested treatment option.

The queries and answers may relate to personal information. The personal information may relate to one or more of potential patient identity, the age of the potential patient, the time that the potential patient has been considering treatment, the name and postcode of the potential patient, any concerns of the potential patient, and benefits of the treatment.

The method may further involve capturing further images of the patient's teeth over time. The method may involve enabling sequential display of the images showing any change in the patient's teeth. The method may further involve prompting the patient to capture the image. The prompting may occur periodically (e.g. weekly). The method may involve providing a progress report regarding the number of images captured.

The method may further involve providing or determining the duration until an event (e.g. wedding, school formal). The providing or determining may involve entering the date of the event. The method may involve providing a countdown until the event. The method may involve displaying treatment tips at pre-determined times throughout the countdown based upon the remaining duration. The method may involve displaying treatment options to the patient based upon the duration.

According to another aspect of the present invention, there is provided an orthodontic treatment suitability system including at least one computational device and configured to: pose one or more queries relating to a potential patient; receive one or more answers to the queries; and determine suitability of an orthodontic treatment based upon the received answers.

According to another aspect of the present invention, there is provided a method for tracking the progress of a patient undergoing orthodontic treatment, the method including the steps of at least one computational device: capturing images of the patient's teeth over time; and sequentially displaying the images showing any change in the patient's teeth.

According to another aspect of the present invention, there is provided a method for motivating a patient undergoing orthodontic treatment, the method including the steps of at least one computational device: providing or determining the duration until an event associated with the patient; and providing a countdown until the event.

In another aspect of the invention, there is provided computerized method of generating a marketing communication for a dental health patient, the method comprising the steps of: with a computer system, automatically: successively generating a communication for each of a plurality of persons, the communications each comprising identifying content to distinguish each person from other persons of the plurality of persons, and customised content relating to an offer to each person, wherein the generating a communication includes accessing a computer-accessible storage medium to determine at least part of the customised content relating to the offer from at least one set of information associated with the offer. In some preferred embodiments at least one customised content generated for a first person's communication is different from a second customised content generated for a second person's communication.

In another aspect, there is provided an apparatus for generating a marketing communication for a dental patient, the apparatus comprising: a computing system; a computer-accessible storage medium coupled to the computing system; computer software executing on the computing system and adapted to automatically cause the computing system: to successively generate a communication for each of a plurality of persons, the communications each comprising identifying content to distinguish each person from other persons of the plurality of persons, and personalized content relating to an offer to each person, wherein the generating a communication includes accessing the storage medium to determine at least part of the personalized content relating to the offer from at least one set of information associated with the offer. In some preferred embodiments, the at least one customised content prepared for a first person's communication is different from a second customised content prepared for a second person's communication.

Any of the features described herein can be combined in any combination with any one or more of the other features described herein within the scope of the invention.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a block diagram of an orthodontic treatment suitability system in accordance with an embodiment of the present invention;

FIG. 2 is a flowchart of a method for determining suitability of an orthodontic treatment using the system of FIG. 1;

FIG. 3 shows a mobile phone screen displayed when capturing a smile during the method of FIG. 2;

FIG. 4 shows a mobile phone screen displayed when selecting problem teeth during the method of FIG. 2;

FIG. 5 shows a mobile phone screen displayed when selecting problems with individual teeth during the method of FIG. 2;

FIG. 6 shows a mobile phone screen displayed when selecting a bite type during the method of FIG. 2;

FIG. 7 shows a mobile phone screen displaying a generated suitability report, indicating low suitability for a reduced treatment, during the method of FIG. 2;

FIG. 8 shows a mobile phone screen displaying a generated suitability report, indicating high suitability for a reduced treatment, during the method of FIG. 2;

FIG. 9 shows a mobile phone screen displaying a progress report regarding the number of images already captured;

FIG. 10 shows a mobile phone screen for capturing another image;

FIG. 11 shows a mobile phone screen for initiating a countdown to an event; and

FIG. 12 shows a mobile phone screen displaying options and tips leading up to the event of FIG. 11.

FIG. 13 is a hardware block diagram of an example implementation of the invention;

FIG. 14 is a flow chart of system software used in the implementation of FIG. 13;

FIG. 15 is a flow diagram which illustrates a preferred method according to the invention;

FIG. 16 is a flow chart illustrating the data input module of a preferred embodiment and method of the invention;

FIG. 17 is a flow chart illustrating the processor module of the preferred embodiment and method of the invention;

FIG. 18 is a flow chart illustrating an example of the organization and flow of the processor module;

FIG. 19 is a flow chart illustrating the organization and flow of a output module of a preferred embodiment;

FIG. 20 is a flow chart illustrating the organization and flow of the production and scheduling module of a preferred embodiment and method;

FIG. 21 is a flow chart illustrating the organization and flow of an analysis module of a preferred embodiment;

FIG. 22 is a flow chart illustrating the organization and flow of a new business processing module of a preferred embodiment;

FIG. 23 is an illustrative embodiment of a flow chart of an example reply system of the invention;

FIG. 24 is an illustrative example of an embodiment of a reply generation system of the invention; and

FIG. 25 is a simplified overview of an embodiment of the invention showing some example important features of the system software and reply generation module.

### DETAILED DESCRIPTION OF PREFERRED EMBODIMENTS

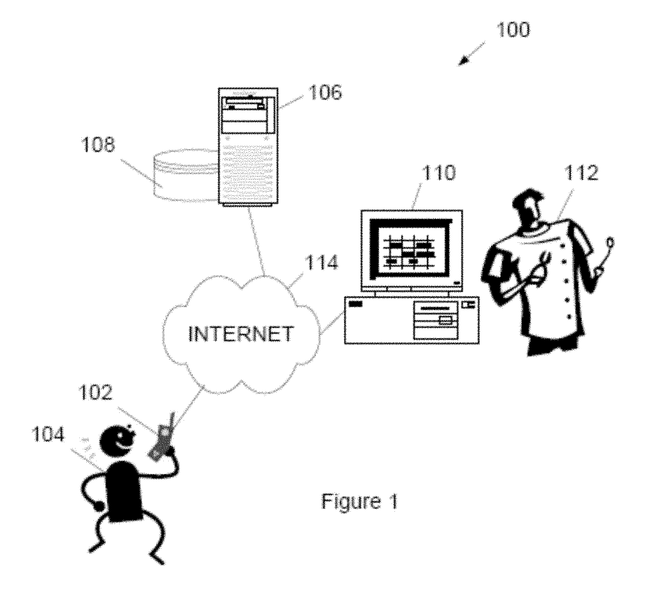

According one aspect of the present invention, there is provided an orthodontic treatment suitability system 100 as shown in in FIG. 1. The system 100 includes a mobile phone 102 (i.e. computational device) executing application software (i.e. an App), and equipped with a camera for capturing images of teeth. The smart phone 102 of the system 100 poses one or more queries relating to a potential patient 104 and receives one or more answers to the queries from the patient 104. The system 100 further determines the suitability of an orthodontic treatment based upon the received answers. Advantageously, the potential patient 104 can conveniently perform a self determination relating to the suitability of the orthodontic treatment, prior to arranging a formal assessment with an orthodontist.

The system 100 further includes an administration server 106 hosting a website and from which the App can be downloaded. The server 106 includes a database 108 storing patient records that include the answers and a report including the determined suitability.

The system 100 further includes an orthodontist's computer 110 which enables an orthodontist 112 to remotely access, over the internet 114, the stored records in the database 108.

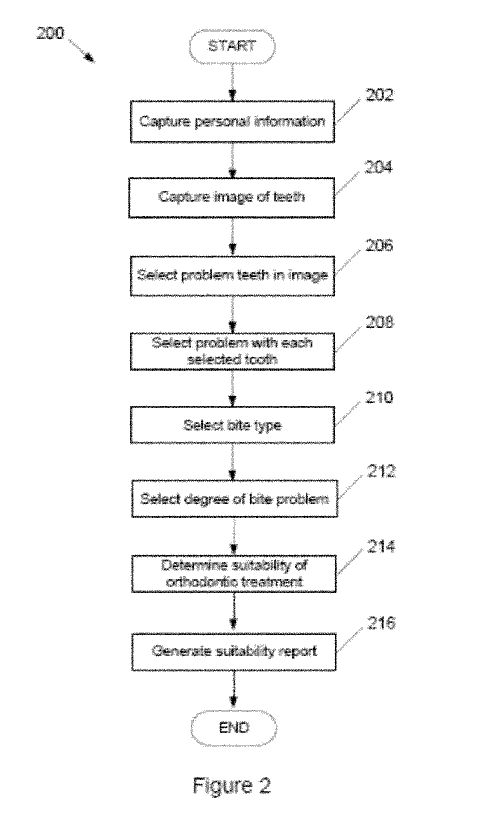

A method 200 for determining suitability of an orthodontic treatment is now described with reference to FIG. 2.

Initially at step 202, the mobile phone 102 of the system 100 executing the App, poses personal information queries relating to a potential patient 104 and receives answers to the queries. The personal information relates to whether or not the treatment is for the phone user or another potential patient 104 (e.g. dependant), the age of the potential patient 104, the time that the potential patient 104 has been considering treatment, and the name and postcode of the potential patient 104.

The personal information also relates to any concerns of the potential patient 104 including whether braces look ugly, whether the patient 104 perceives that treatment is unaffordable, whether braces are applied for too long, whether pain is involved in the treatment, and whether or not there is value in having the treatment (cost versus benefit).

The personal information also relates to perceived benefits of the treatment including more confidence, aesthetics such as a beautiful smile, a new start, and looking good in photos.

Some of the queries may be posed in the form of a checklist or slider bar, and finite answers may be elicited using these tools. Not only do compiled answers stored in the records of database 108 at the administration server 106 provide useful statistical information for the orthodontist 112, but they also enable the orthodontist to better assist individual patients 104 should treatment be sought. Further, the structured personal information queries provide a check to reaffirm that the potential patient 104 is making the right decision in seeking treatment.

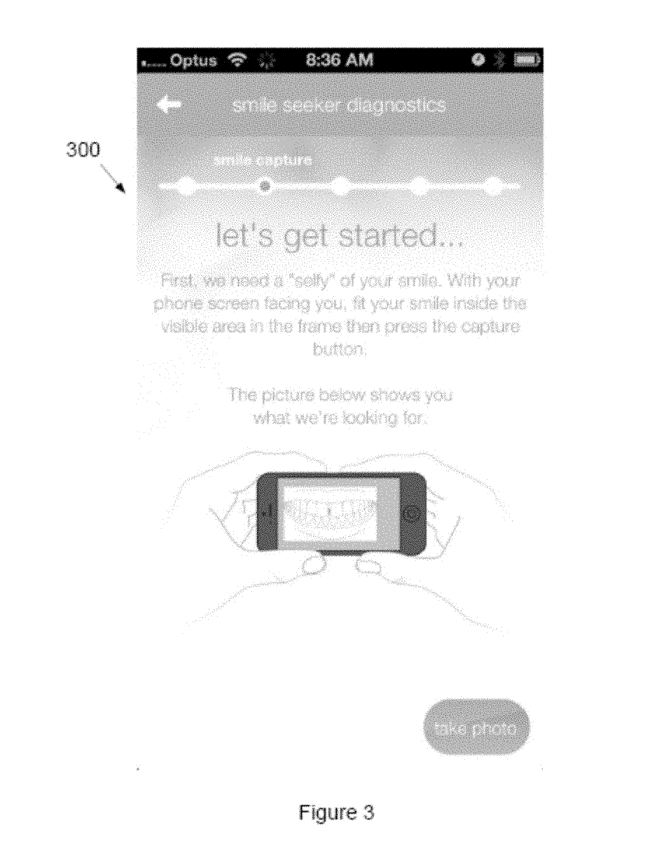

At step 204, the mobile phone camera of the system 100 captures an image of the potential patient's smile. In particular, the App prompts the patient 104 to capture the image as shown in the mobile phone screen shot 300 of FIG. 3.

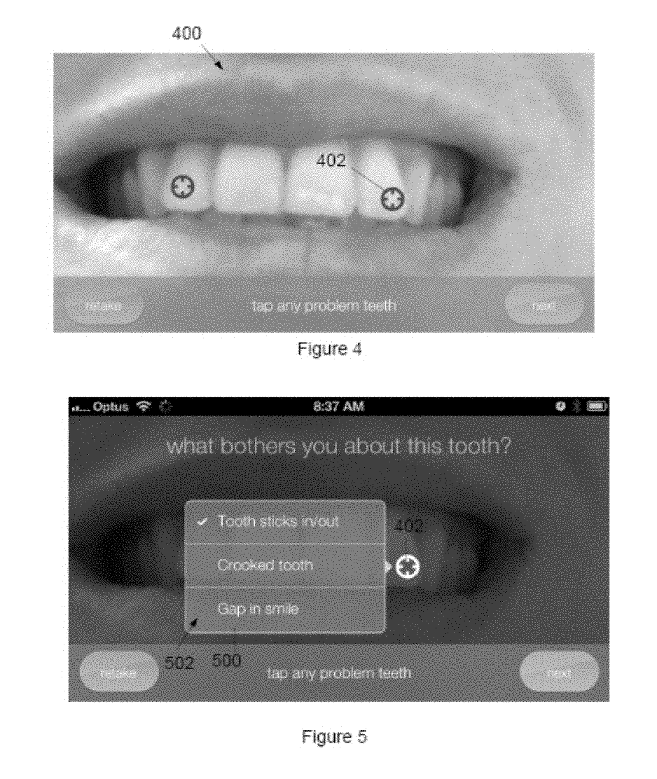

At step 206, the mobile phone 102 of the system 100 queries the patient 104 to select any problem teeth in the captured teeth image 400 as shown in FIG. 4. The phone 102 receives answers as the patient 104 taps on the individual teeth 402 in the image 400.

At step 208, the mobile phone 102 receives answers from the patient 104 in the form of selected problems associated with each selected tooth 402. As shown in FIG. 5, the patient 104 selects a problem item 500 from a pick list 502 to identify the problem with each selected tooth 402. The first selected problem tooth (e.g. gap, crooked, angled in, angled out, etc.) is assigned an associated weighted score from Table I below (e.g. first crooked tooth=weighting of 7).

TABLE I

| Individual | |
|---|---|
| Teeth | Score |
| Gap | 7 |
| Crooked | 7 |
| Angled In | 9 |
| Angled Out | 9 |

Any additional teeth are assigned a weighting of 5. For example, a first crooked tooth and a second gapped tooth will result in a weighting of 12 (i.e. 7+5)

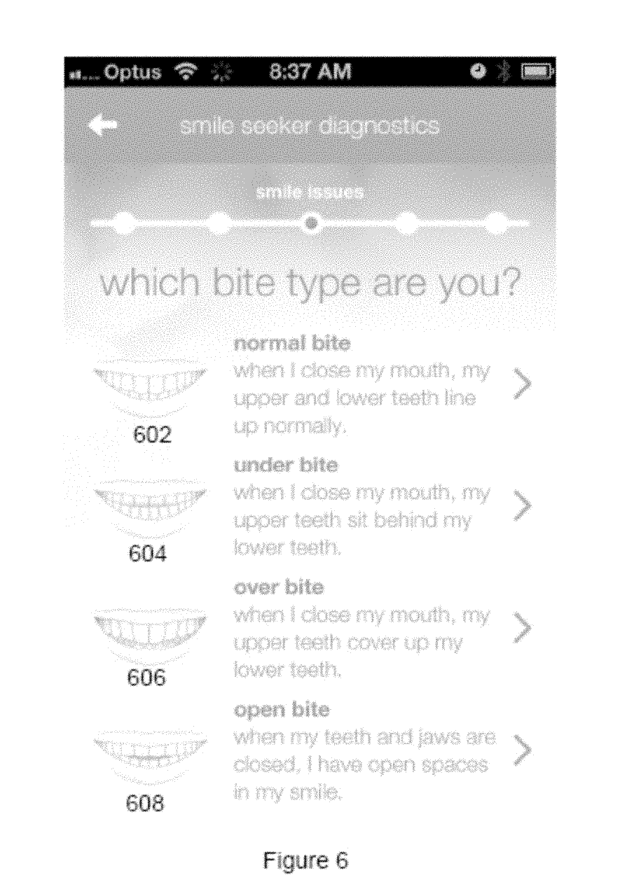

At step 210, the mobile phone 102 queries the type of bite of the patient as shown in FIG. 6. The types of bite include a normal bite 602, under bite 604, over bite 606 and open bite 608. The patient 104 selects a particular type of bite which, for normal bite 602 and open bite 608, is directly assigned a weighted score as shown in Table II below.

TABLE II

| Bite Type | Score | | |
|---|---|---|---|
| Normal | 0 | | |
| Underbite: | | Mild | 26 |
| | | Moderate | 52 |
| | | Severe | 65 |
| Overbite: | | Normal | 26 |
| | | Deep | 52 |
| | | Very Deep | 65 |
| Openbite | 65 | | |

At step 212, for an under bite 604 or over bite 606 selection at step 210, the mobile phone 102 queries the degree (e.g. mild, moderate, severe) of the bite condition of the patient 104. The patient 104 selects a degree which is assigned a weighted score as shown in Table II.

At step 214, the mobile phone 102 determines the suitability of the orthodontic treatment based upon the received answers. In particular, the suitability of treatment is a percentage determined using the assigned weights as follows:

Percentage suitability for reduced treatment=sum of weighted individual teeth (table 1, step 208) +weighed bite (table 2, steps 208 & 210)×100 divided by 1.

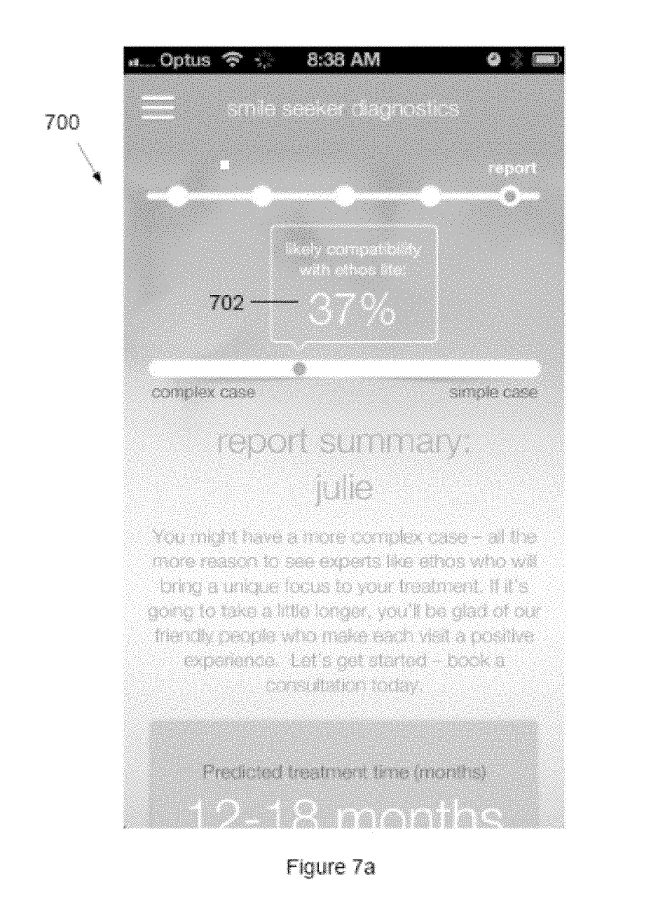

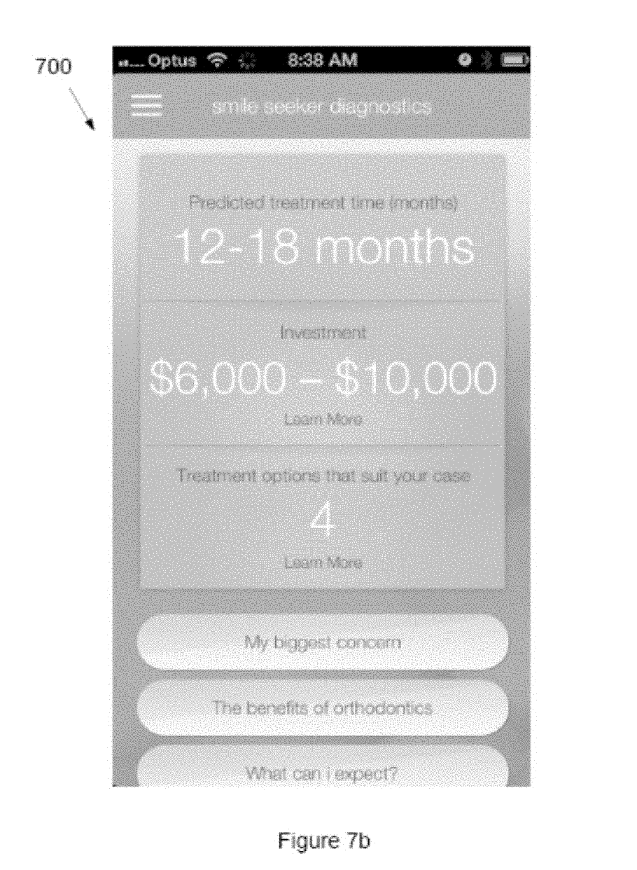

At step 216, the mobile phone 102 provides a suitability report 700 as shown in FIG. 7. The report 700 includes the determined suitability percentage 702 for the treatment which is a reduced treatment. As shown in FIG. 7a, the percentage 702 is also displayed graphically whereby the determined suitability is proportional to the simplicity of the patient's case based upon the answers. As shown in FIG. 7b, the report 700 further includes a predicted treatment time, cost estimate of the treatment, and an indication of a suggested treatment option.

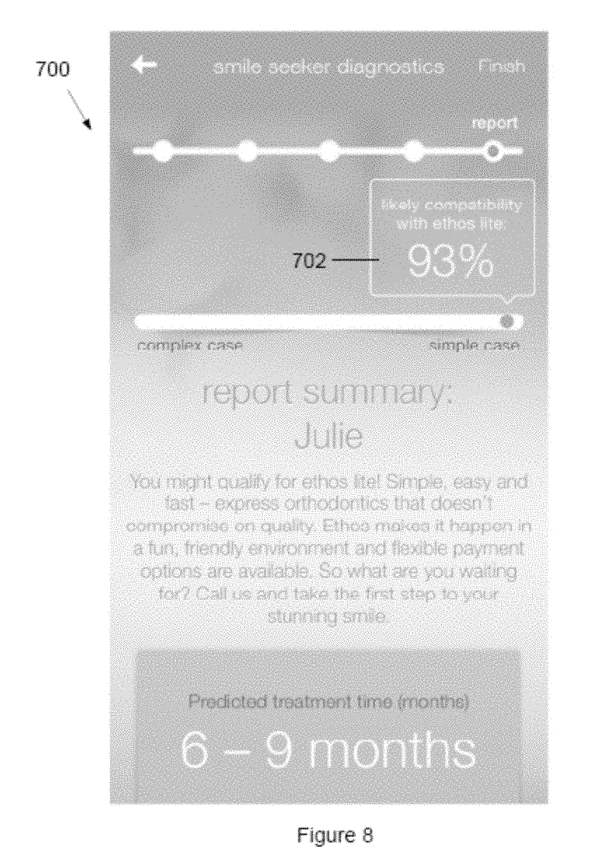

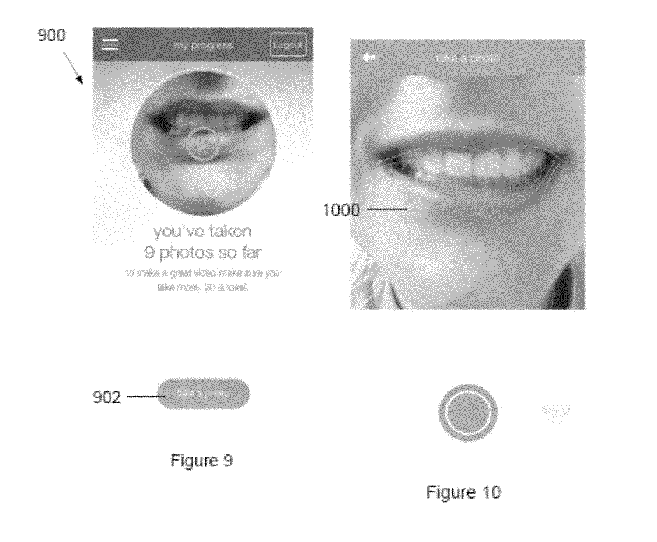

If the percentage 702 is below 50% as shown in FIG. 7a, then a full treatment is recommended. If the percentage 702 is above 50% as shown in FIG. 8, then a reduced orthodontic treatment is suitable thereby encouraging those with limited means to seek treatment.

The report 700 is stored in a patient record in the database 108, and can be later accessed over the Internet 114 by the patient 104 or orthodontist 112. At any time, the patient 104 undergoing treatment will be able to log into their account using the App and thereby gain access to the report 700 stored in the patient record in the database 108.

As shown in FIGS. 9 and 10, the patient 104 can also log into their account and capture further images of their teeth over time. The images are stored in the database 108.

Turning to FIG. 9, the patient's smart phone 102 provides a progress report 900 regarding the number of images already captured and stored in the database 108. The smart phone 102 displays the selection button 902 prompting the patient 104 to capture another image. Typically, the administration server 106 periodically (e.g. weekly) prompts the patient via their smartphone 102 (e.g. using SMS or e-mail) to log in and capture a new image.

Turning to FIG. 10, the patient's smart phone 102 displays a reference location and orientation 1000, in the form of silhouetted and superimposed teeth, for locating and orienting the patient's teeth in the captured image. The patient's smart phone 102 can be used to sequentially display the captured images stored in the database 108 in the form of a video thereby showing any change in the patient's teeth over time. The display of this video gives the patient 104 encouragement in seeing the alignment of their teeth during treatment, which may not otherwise be appreciated during a long treatment where changes are somewhat incremental.

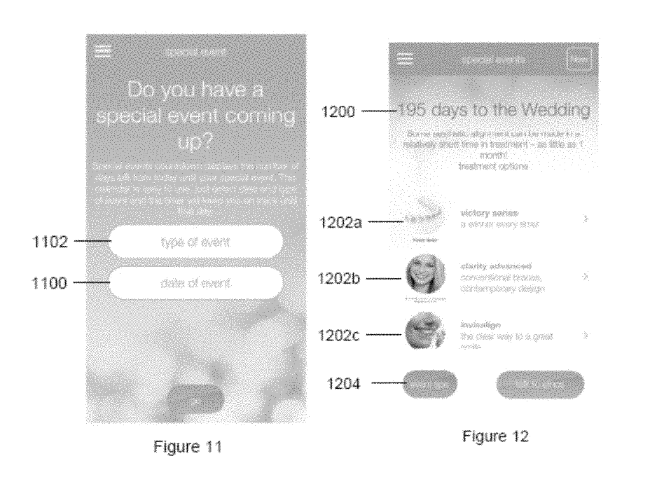

Turning to FIG. 11, the patient 104 can also use the App to enter the date 1100 of an event 1102 (e.g. wedding, school formal, etc.), and this information is also stored in the database 108. The duration until the event is determined and monitored by the administration server 106 which provides a running countdown until the event.

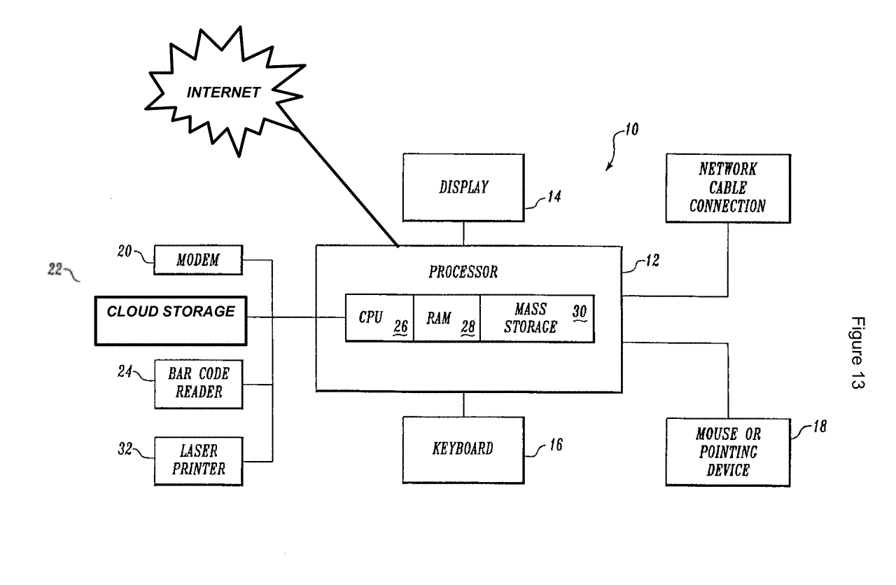

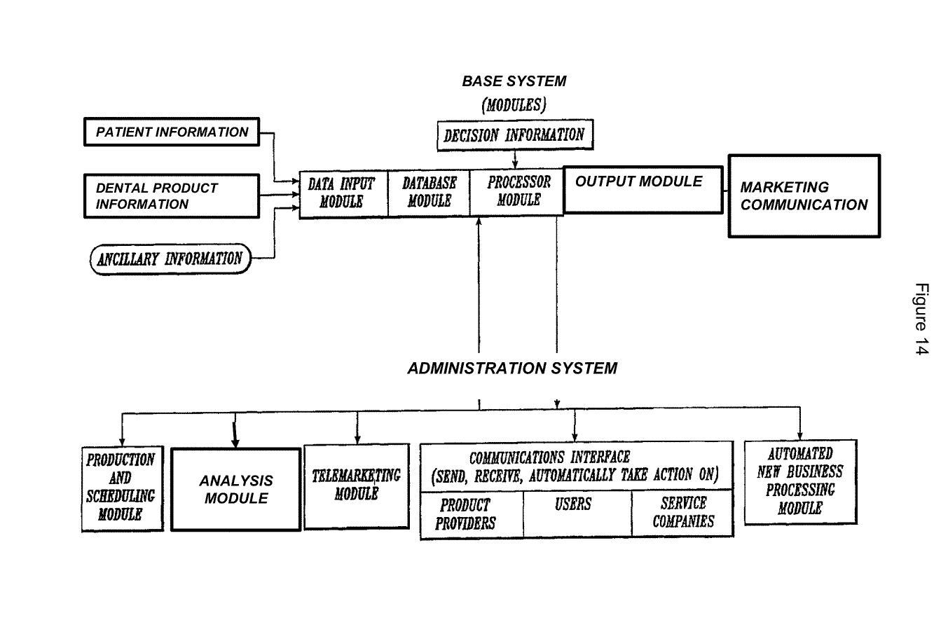

Turning to FIG. 12, the patient's smart phone 102 displays the countdown 1200. The smart phone 102 also displays determined treatment options 1202a, 1202b, 1202c to the patient 104 based upon the duration (or remaining duration) until the event. Furthermore, as the patient 104 logs into their account throughout treatment, the smart phone 102 also displays treatment tips 1204 (e.g. whitening, oral hygiene, etc.) at pre-determined times (e.g. weekly, monthly, quarterly until event) throughout the countdown based upon the remaining duration. The tips can be sent by e-mail or SMS from the server 106. Although the patient 104 can elect not to receive tips 1204, the tips 1204 help the patient 104 to track their treatment and remain on track for completing their treatment by the event date 1100.

In accordance with another aspect of the invention, an apparatus and method are provided for automatically preparing marketing communications pertaining to one or more dental products, and/or dental services, and/or dental plans for patients. (The term ‘dental product’ is used herein to refer to any one or more of dental products, dental services and/or dental plans.) This aspect of the invention works most preferably in conjunction with a system and method according to the previously discussed aspect. For example, where inputs such as answers, marketing communications and other correspondence occur electronically and for example via a mobile computing device and for example via an app.

As used herein, the term “Answer” refers to a communication from a patient in answer to an original “marketing communication” sent to that particular patient or a reply communication. The answer may for example include a selection of answer options, for example, “buy,” “more information,” “different amount,” “add further dental information” etc., depending upon the nature of the product or service being marketed. Of note are answers that select nonpurchase type options (i.e. ones that do not include an order to buy) because, traditional marketing generally does not permit and generally does not cope with these types of answers. To facilitate the automatic reply scheme of the invention, each answer is tagged with a tag. Answers can be received by a variety of transmission methods, e.g. electronically from call centers, users of the system, faxes, internet, etc. In some preferred embodiments, answers are received via inputs into a web site or mobile computing device, for example via an App. In one particularly preferred embodiment, answers are received via an App as herein described.

Each marketing communication according to the invention includes at least one “contextual portion.” A “contextual portion” as the term is used herein, refers to a portion of a marketing communication which may vary from marketing communication to marketing communication. The contextual portion may serve as a location marker in the marketing communication, at which location the system and method according to the invention may insert or provide certain “contextual portion information” selected by the system and method. The contextual portion information, which may take a number of different forms, is selected using the decision information so that it is appropriate for, and to a certain extent individualized for, a particular patient. Contextual portion information may come from any suitable source, including for example databases of publicly available information, information inputted by a user or a patient, etc. In some preferred embodiments, contextual portion information is inputted during interaction between a patient and the software of the system and method of the invention. Such contextual portion information may for example comprise responses to prompted questions, expressed preferences, concerns, likes, dislikes, etc. For example, a particular patient may not like the look of a particularly orthodontic treatment apparatus which will add to the contextual portion information to ensure that such a treatment apparatus is not offered as part of a dental or orthodontic plan.

“Correspondence” as used herein means any communication, whether delivered by mail or by other means, and includes verbal communication.

“Dental” as the term is used herein should be interpreted broadly to include anything related to oral health, hygiene, maintenance or care and therefore specifically includes orthodontic related subject matter.

“Dental product information” as used herein refers to information which identifies, describes, explains or otherwise pertains to the dental product or products (including services and plans) which are to be the subject of some or all of the marketing communications, as explained more fully below.

“Host information” as used herein includes information which is included within or otherwise pertains to a primary communication or a collection of primary communications. Examples of host information would include such things as dental health checkup reminder details, the type of dental product(s) used by a patient in the past, the amount of services or products reflected in a particular bill, account information, a statement of account, etc.

A “marketing communication” as the term is used herein refers to a communication which is prepared for a given patient and which provides information to the patient about one or more selected dental products and/or dental services and/or related dental plans. A marketing communication, for example, might include a solicitation or similar marketing or advertising message in which the one or more dental products, services, etc. are presented to the patient in an attempt to sell the product, service, etc. to the patient, provide information on the products and services, provide a notice pertaining to such products or services, etc. A marketing communication may assume the physical form of a paper or papers which would be integrally attached to a primary communication, a computerized document which is adapted to be incorporated with a computerized primary communication, an electronic mail document, an instant message, a message within an App etc.

“Patient” as the term is used herein should be interpreted broadly to include an actual patient or customer of the user of the system and/or method according to the invention, or the party for whom the system and/or method is employed. The term “patient” also includes a potential patient or customer, or a similar party for whom a communication is prepared. A patient is assumed for illustrative purposes here to be a party for whom a patient record has been created in the patient database as described more fully below.

“Patient information” as used herein means information which pertains to a particular patient, or to a particular set or group of patients. Examples of patient information include a patient name, address, telephone number, age, marital status, occupation, employer, income, health status, dental or oral health status, dental or medical history, etc. Patient information also may include information pertaining to the family or other relations to the patient, such as information on the spouse, children, parents, etc., or medical history of any of them etc.

“Patient record” as used here means a compilation of information pertaining to a particular patient. The patient information is collected into an automated or computerized database, which is referred to herein as a “patient database.” In this context, a patient record is a single record for a given patient within the patient database. The fields of each patient database record include the various items of patient information, examples of which are provided above. The organization of this patient information database and the records and fields within it are typically in conformity with the data organization and structures of known relational databases.

“Primary communication” as used herein means a communication, such as an account statement, notice, correspondence, etc., other than a marketing communication, which is to be sent to a patient. The primary communication typically would constitute the primary purpose for contacting or communicating with the patient.

“Reply” as used herein means a responsive communication generated by a user of the system of the invention that responds to an “answer” from a patient. Each reply preferably includes a tag corresponding to the tag of the patient answer to which it is responsive. Each reply is preferably individualized beyond merely a name and address of the patient, to include such personalized details as specific product information requested, alternative quotations requested, and the like, as discussed herein.

“Tag” as used herein refers to any means of identifying a communication (including answers and replies) as one relating to a particular patient, in other words, it is an identifier that allows tracking of the communications to and from each patient to distinguish these from those communications to and from other patients in a plurality of such marketing communications.

One of many possible embodiments of the apparatus according to the invention is illustrated in FIG. 13. It will be readily understood by those of skill in the art that the apparatus may vary significantly from the example shown. The example shows an embodiment including a computer system using a networked patient-server database system architecture with a number of computer nodes or computing devices. A network server 10 is shown in FIG. 13. Computing device nodes would be very similarly configured. In addition to the server and workstation nodes, system nodes also may include output devices, such as laser printers (not shown). Each of the individual computing devices or nodes within the system may for example include a processor 12, a display 14, a keyboard 16, a mouse, light pen, or similar pointing device 18, a modem 20, a cloud storage 22, and a bar code reader 24. In some embodiments an individual computing device node may be as simple as a hand held computing device.

The processor of each computer node (server or workstation) includes a central processing unit (CPU) 26, random access memory (RAM) 28, and at least one mass storage device 30, such as a hard drive and/or a diskette drive. The design and configuration of CPU 26 is not limiting, and may include any of the CPU designs sold as standard components with high-end personal computers or business machines.

Display 14 should be compatible with the processor, and preferably should have a resolution of at least about 800×600 pixels. Many other and better commercially-available monitors would suffice. Keyboard 16 may be any modern keyboard which is compatible with the processor. Keyboard 16 comprises a means for the system user to selectively input information, decisional information or criteria, module instructions, and the like into the system where manual input is called for.

The mouse, light pen, track ball or similar pointing device 18 is used to navigate the graphical user interface of the system, which is designed to increase the ease of use of the system, as will be described more fully below. It also comprises means for inputting information into the system, particularly where graphical interface environments are used in implementation. These devices may be obtained from commercially-available sources as off-the-shelf components.

Modem 20 is used for communicating with computer systems remotely from processor 12. The design of modem 20 also is not limiting, and its specific design will depend upon the design of processor 12, the design and configuration of the computer or computers to be communicated with, and similar generally known factors in a given application. In the preferred embodiment of FIG. 1, modem 20 comprises a high speed modem which is compatible with processor 12, such as are commercially available.

Cloud storage 22 may be used for inputting bulk files and lists, as described in greater detail below. The specific design and configuration of cloud storage 22 also will depend to a large extent on the design and configuration of other system components, and on the particulars of the application. It should be noted that some or all of the software components of the system and method of the invention may reside on a cloud storage device. In addition, a key source of communication is via one or more computer networks such as the internet. Consequently an important element of the system is the connection to the internet.

Bar code readers may be used to speed manual input of data and also to record answers and other correspondence from patients. They should be industry-standard readers capable of reading the major bar code presentations, such as Code-39 bar codes, and inputting the scanned information to processor 12. An optical scanner (not shown) also may be provided as an optional input device.

The system includes a high-quality laser printer 32, such as any of the high-end commercially-available laser printers available for processors of the type employed in this system. Large-volume commercial laser printers also may be used for producing large quantities of marketing communications at rapid rates. The system also may include as an output a modem such as modem 20 or similar on-line or networked connection.

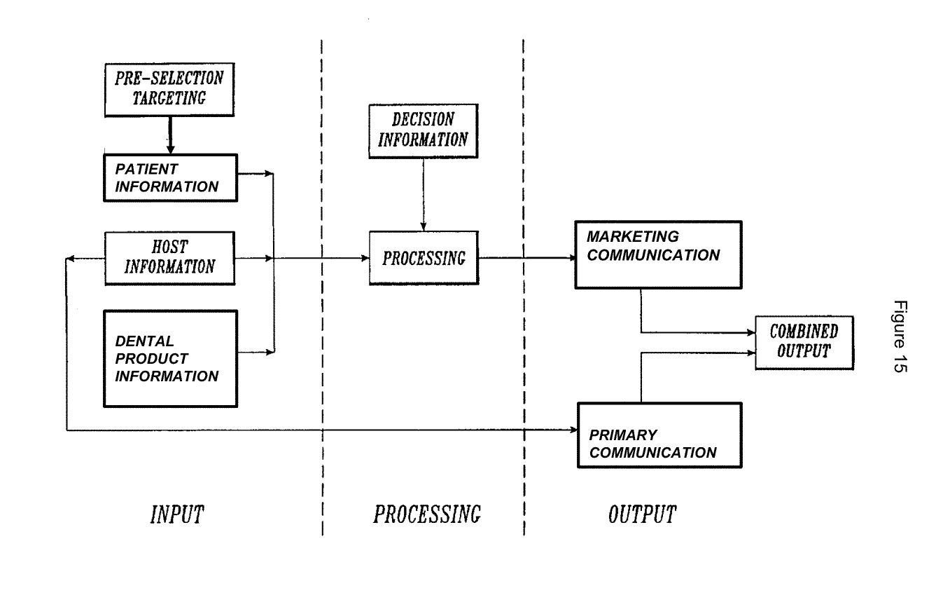

Processor 12 has resident within its accessible memory system computer software or system software, an example flow diagram of which is shown in FIG. 14. Note that in web-based or server-based implementations of the invention, processor 12 would reside on the server. The software has a “base” system for processing tasks such as selecting contextual portion information and preparing marketing communications. The system software also includes an “administration” system for supporting the base system, facilitating the communication or marketing program, providing administrative and management reports and functions, and other tasks. The base system includes a plurality of modules, including a data input module, a database module, a processor module, and an output module. The administration system includes a production and scheduling module, an analysis module, a telemarketing module, a communications interface, and a new business processing module. Each of these systems and modules will be described in greater detail below.

A flow diagram which outlines steps of a preferred method is shown in FIG. 15. Referring to the left portion of the diagram, the method includes a step of inputting information of various types into the system. Although the specific forms of information to be inputted will vary from application to application, they will include patient information. This patient information may be pre-selected or pre-sorted, for example, using known market segmentation or targeting techniques, or what has been referred to recently as “database mining.” Dental product information, and in some cases host information, also may serve as inputs.

The preferred method also includes a processing step (center of FIG. 15) in which decision information is used to automatically select contextual portion information for inclusion or provision in a marketing communication or communications. The output of the processing step (right portion of FIG. 15) is one or more marketing communications which include the contextual portion information. The contextual portion information is used to make the marketing communications highly individualized or personalized. The marketing communications are adapted to be combined with corresponding primary communications for the respective patients to create a corresponding plurality of combined outputs. This combination can be very advantageous over prior known methods, e.g., based upon the ability to make the marketing communications highly personalized and at the same time delivering the marketing communication together with the primary communication to achieve the corresponding benefits.

As an initial step in the preferred method, one generally would determine the dental product or products which are to be presented in the marketing communications. This selection may be made, for example, based upon the nature of the patient population itself, the desired dental product or products to be offered, etc. It should be appreciated that this step need not necessary occur first. The selection of dental products, for example, may be one of the functions which the system performs, e.g., during its processing step as described more fully below.

The preferred method includes a step of providing a presentation for the marketing communication wherein the marketing communication presentation includes a contextual portion. Each of the marketing communications includes at least one contextual portion in which contextual portion information is inserted or otherwise provided. The contextual portion information is selected based upon the decision information.

The term “presentation” is used according to its common meaning and refers to the general layout and appearance of a communication. The presentation may assume any one of a wide variety of forms, depending upon the dental product or products involved, the intended patient base, the communication medium, the desired or available space, the tastes and specific needs of the communication designer, etc. Presentation inputs may include such things as typographical presentation information (e.g., top, bottom and side margins), fonts, graphics, displays and display locations, text links, QR codes, etc. The presentation also may include content designations. In more advanced applications, a plurality of presentations may be selected, and the system and method may be adapted to select from among the presentations for a given patient and marketing communication.

The communication presentation includes at least one contextual portion or contextual portion, as noted above. Preferably, the presentation of each communication will include a plurality of contextual portions or contextual portions. Each of these contextual portions constitutes a portion or segment of the marketing communication which, in the actual communications, will vary from patient to patient, and from marketing communication to marketing communication. The contextual portion may assume any one or combination of a wide variety of informational types and content components. Examples would include patient information (generally other than a patient identification), dental product information, ancillary data, contextual portion text, etc. A given communication presentation may include a plurality of contextual portions of a given type, e.g., all patient information, or it may comprise different types of contextual portions, e.g., patient information, dental product information, etc.

The preferred method includes steps of inputting into a computer-accessible storage medium contextual portion information other than a patient identification, and inputting into the storage medium decision information. The preferred apparatus similarly is provided with appropriate input means for inputting these and other various categories of information into a computer-accessible storage medium. The method and apparatus of the invention are adapted to process various types of information in generating and outputting the marketing communications.

Initial system inputs typically and preferably would include patient information, dental product information, decision information, text information, and in some applications ancillary information. Any one of these classes of information could comprise contextual portion information, although decision information often is used primarily for internal systems purposes.

The types and amounts of patient information provided to the system and used in the method will depend upon the types and amounts available, the desired marketing communication presentation, the decisional information or logic to be used, etc. Patient information may comprise a variety of types of information pertaining to a particular patient, or to a particular class of patients. In most instances, this patient information will include a patient identification. “Patient identification” as used herein includes the information about the patient which uniquely identifies a given patient and permits correspondence or communications to be forwarded to the patient. In most instances this patient identification constitutes the patient's name, or the patient's name and post office address. A patient account number also may be included. This term is intended to be construed narrowly, for example, to include only the minimum information, usually name and postal address, necessary to uniquely identify the patient and forward the communication to the patient. It may not include, for example, information which may happen to be unique to the patient and may uniquely identify the patient under analysis, but which information is not typically used to identify the patient. Individual components of patient identification other than patient name also typically would not be included within the scope of the term patient identification as used herein. A patient's postal zip code used separately from the postal address, for example, would not qualify as patient identification.

A wide variety of types of patient information other than the patient identification may and often is available. Typical examples might include the patient's age, occupation, employer, annual income, marital status, whether he or she smokes, family information, geographic information other than patient address information (e.g., zip code, city, county, state, etc.), purchasing information such as purchasing practices and proclivities, patient asset information, liability information such as mortgage or loan information, patient activity information (e.g., hobbies, sporting activities, etc.), and other psychographic, demographic and general patient data or information.

“Dental product information” as used herein refers to information which identifies, describes, explains or otherwise pertains to the dental product or products (including dental services and dental plans) which are to be the subject of some or all of the marketing communications. Dental product information includes product pricing information and product non-pricing information. Pricing information includes the pricing for the relevant products, and perhaps other information relevant to pricing, for example, such as the time period during which particular prices will be available, payment terms, available financing terms, etc. Product non-pricing information includes any dental product information other than product pricing information. Examples of product non-pricing information would include product-related descriptions, conditions of offer, classes of patients for whom the product is available (e.g., “issue constraints” as used in the insurance industry), annuity tables, actuarial tables, etc.

The dental product information may pertain to a single product, or to a plurality of different dental products. Combinations of dental products across fields, such as oral hygiene and orthodontistry, also are possible.

“Ancillary information” as used herein refers to virtually any type of data or information useful for the system and/or method in performing the intended functions, but excludes patient information, dental product information and decision information. Examples of such ancillary data or information would include statistical information, geo-code data, and the like. Non-patient specific information also may be included in this category, such as demographic, psychographic or buying habit data. Incidentally, the term “information” is used broadly herein to include quantitative data as well as other forms of information.

Text information comprises text, e.g., in the form of an alphanumeric character or character string, a word, a phrase, a sentence, a paragraph, or even a graphical symbol. The preferred form of text information in many applications involving the marketing of dental products would comprise a phrase, i.e., a collection of words, which would be part of a sentence or paragraph of fixed text within the marketing communication.

Text information as used herein can and often will overlap with the other categories of information as defined herein. Text information may, for example, comprise or pertain to patient information. In the example provided immediately above, the text information pertains to dental product information. Text information also may comprise or pertain to ancillary information, decision information, etc.

The decision information to be provided to the system may and usually will vary from application to application. This decision information typically would be inputted as part of the system initialization for a given run. The decision information generally will comprise criteria or conditions used for the selection of contextual portion information. The decision criteria preferably comprise programmed database queries which are used in conjunction with the patient database, and perhaps a dental product database and/or an ancillary information database to select records, to select fields within records, and the like. The decision information also may comprise conditions and instructions for selection of information from lookup tables and similar data structures.

According to the method of the invention, decision information is used to automatically select contextual portion information for insertion or inclusion in the contextual portion or contextual portions of the marketing communication or communications. This contextual portion information preferably includes information other than, or in addition to, a patient identification as that term has been defined herein. The contextual portion information may be selected for insertion into the contextual portions or contextual portions of the marketing communication for one or more of the patients.

The contextual portion information may comprise part or all of the information provided to the system as the patient information, the dental product information, the ancillary information, text information, and even the decision information. This contextual portion information may comprise virtually any form of patient information, but preferably, as noted, it would be other than, e.g., in addition to, a patient identification, most notably the patient's name, address, account number, etc. The contextual portion patient information may, for example, comprise information pertaining to the patient such as patient age information, health information, patient family information, patient geographic information other than patient address information, patient purchasing information, patient asset information, patient liability information such is information about a mortgage, patient dental income information, patient occupation information, patient activity information (e.g., sports activities, recreational activities, etc.), and the like.

Where the contextual portion information comprises dental product information, this contextual portion dental product information also may assume a wide variety of forms. As noted, the contextual portion dental product information may pertain to a single dental product or to a plurality of different dental products.

The contextual portion information also may comprise or pertain to ancillary information, such as statistical demographic information, geo-code data, psychographic data, economic data pertaining to more than one person, e.g., pertaining to persons other than merely to a single patient, and combinations of these.

The contextual portion information also may comprise text or text information. Where it would be desirable to present differing text in the respective communications, for example, depending upon the age, marital status, etc., of the respective patients, several different versions of text may be used as contextual portion information. Any given one of the text inputs would be used for a particular patient only if that text were appropriate for that patient. As noted, information other than a patient identification, i.e., information in addition to the patient identification information if patient identification is present, may constitute the contextual portion information.

The apparatus according to the invention comprises means for inputting into a computer-accessible storage medium contextual portion information comprising other than (in addition to) a patient identification and decision information. The input means used for a particular application will vary depending upon the presentation in which the information is available. Examples would include a keyboard, a disk drive, a cloud storage, a hard drive, a modem, an optical scanner, a bar code reader, a pointing device such as a mouse or track ball, a network link, via the internet, etc. Patient information, dental product information, decision information, ancillary information, etc. may be provided on a data tape, compact disk, diskette, or similar storage medium or via the cloud, in which case the input means correspondingly would comprise a cloud storage, a compact disk reader, a disk drive, and so on. Some records may be available on non-resident databases, as noted. This is increasingly the case as online networks such as the Internet gain widespread use and acceptance. In such instances, the information may be received via modem 20.

The input means of the preferred embodiment may include any one or any combination of keyboard 16, pointing device 18, modem 20, cloud storage 22, bar code reader 24, an optical scanner, mass storage device 30 (e.g., hard drive or diskette drive), and equivalent input devices. With reference to FIG. 1, for example, information may be directly entered using keyboard 16. In some instances, bulk information may be available, for example, comprising lists of patient records, in which case the input devices more suitable for transfer of bulk files would be used. Diskette drive 30, for example, as would come as standard equipment with the types of processors noted above, may be used.

The input means preferably is adapted for inputting such data and information both individually and automatically in bulk. Automatic or bulk input is done essentially or entirely without human intervention. This is particularly desirable when inputting patient information, which ideally would be capable of being inputted as patient records without human intervention between input of the respective patient records.

The decision information may take a number of forms. The means for inputting the decision information therefore may assume different forms, such as those identified above and their equivalents. Preferably, the decision information will comprise one or more computer programs which include database query commands to query or filter the patient information, dental product information, etc. according to desired conditions or criteria. The preferred input means for this task accordingly would comprise keyboard 16 and/or tracking and pointing device 18, operated in conjunction with the associated device-related software and software drivers.

The input means is operatively coupled to a computer-accessible storage medium so that the storage medium receives and stores the information as it is inputted. The storage medium according to the preferred embodiment may comprise RAM 28, mass storage device 30, other memory within CPU 26, cloud storage 22, and any combination of these. The storage medium according to this aspect of the invention may comprise any storage device or medium capable of storing the inputted information and storing it for subsequent retrieval and transmission ultimately to CPU 26. The storage medium need not be directly connected to or directly in communication with CPU 26, provided it is capable of transferring the information to CPU 26 upon the appropriate command.

The inputting of data and information in the preferred embodiment may be carried out as part of the data input module as depicted in FIG. 14. This module forms part of and interacts with the inputting means to receive the inputted patient information, dental product information, and possibly ancillary information and text, and to store the information in an appropriate storage medium, such as mass storage device 30 or RAM 28.

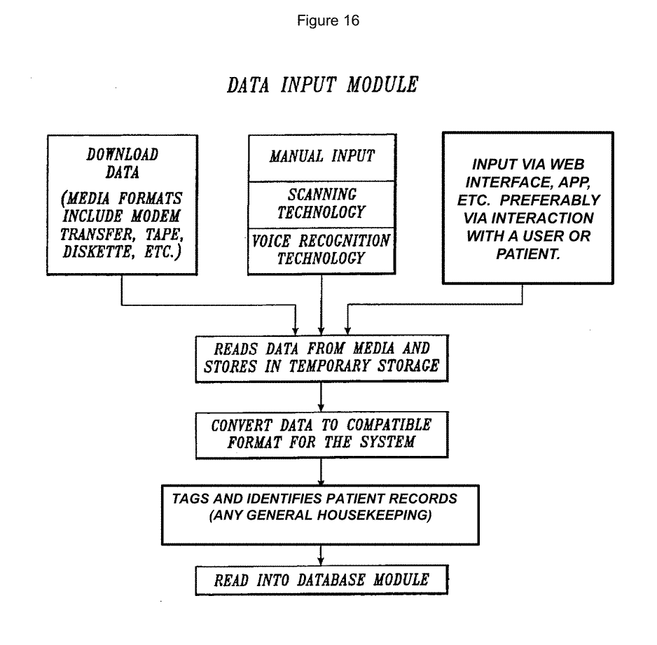

The data input module performs tasks related to inputting information into the system. An example of the organization and task flow of the data input module is shown in FIG. 16. As noted above, data may be entered manually or automatically. For example, information may be entered using scanning technologies. Bar codes may be used on advertisements, information cards and other documentation. Scanners such as those commercially available for use with processor 12 may be used to read the bar coded information. Similarly, an optical scanner may be used to scan an entire page or document, and standard image processing software may be used to read information from the scanned patient information from the scanned input. Information may be input into the system in any suitable way. In some preferred embodiments, a user interacts with the server via the internet, for example via a mobile computing device. The user may complete an online form, or respond to prompts or use any other suitable method in order to input information (for example voice to text input via the mobile computing device). In some embodiments, the user interacts with an App as herein described and thereby adds additional information to the patient database.

The invention is not, however, limited to these input modes, and others may be used. For example, as voice recognition technology develops, there very well may be the ability to input patient information merely by voicing that information into a voice recognition device, which would translate the voice information into digital patient data.

The task of automatically or semi-automatically sending large numbers of communications efficiently and cost effectively generally will require that the system receive or gather on its own large volumes of patient information. For a given patient, the system is adapted to retrieve patient information and, depending upon the circumstances, other information as well. Inherent advantages of using an automated environment to undertake these tasks is the tremendous speed with which computers can retrieve, process and store large volumes of information.

The data input module of this embodiment and method inputs data into the system from one or more of the input devices for the system, such as modem 20, cloud storage 22, or bar code reader 24. The details of the data input module will depend to a certain extent upon the type of data to be input.

With further reference to FIG. 16, as data is inputted, the data input module stores it in a temporary storage area within processor 12. If necessary or appropriate, the data is converted to a presentation compatible with the system. For example, as is known in the database arts, it is sometimes necessary to import or export files to convert one database presentation to pre-defined database structure. In this embodiment, the data input module also may tag and identify patient records as they are inputted, and perform general and routine “house keeping” tasks on the data.

Once these tasks have been performed by the data input module, the properly-presented patient information is transferred to the database module. In the preferred embodiment, the database module comprises a relational database essentially equivalent to commercially-available database packages.

The database module of the preferred embodiment stores patient information for general use by the system, as explained more fully below. The database stores patient information so that each patient is represented by a record in the database, and the various items of information to a given patient are contained within fields under the record for that patient. Examples of the structure and contents of a patient database for orthodontic treatment, for example, may include the following fields:
Name
Address (including zip code)
Age
Marital Status
General Health
Medical history
Dental records
Dental history

The database module also may include information other than patient information. For example, this module typically may include a listing or database of dental products and/or dental product information. The dental product information typically would include not only the identification of the products, but information about pricing, conditions on availability, etc. Product availability conditions or constraints as used here refers generally to limitations on the availability of the product, e.g., geographic availability constraints, age range constraints, face value or amount constraints, and so forth. The product-related database also may include descriptions and explanations of the products, e.g., in the form of text information. This will be explained in greater detail in connection with the output module.

According to the method, the decision information is used or processed to automatically select contextual portion information. In the preferred method, the decision information is used to select a subset of the contextual portion information for inclusion in the contextual portion or portions of the marketing communication corresponding to the contextual portion or portions of the marketing communication presentation. The apparatus according to the invention similarly includes processing means operatively coupled to the storage medium for using the decision information to automatically select a subset of the contextual portion information for the patient, or for each patient where processing involves a plurality of patient records. The subset of contextual portion information for a given patient then may be used in the subsequently-prepared communication for that patient to individualize or personalize the communication. As implemented in some preferred embodiments, the processing means comprises processor 12, including CPU 26 and related components, operating under the control of processor module computer software, as shown generally in FIG. 14.

The specific identity and nature of the contextual portion information selected by the processing module may be varied depending upon a number of factors, the most important of which is the decision information as selected by the system user. The processor module provides tremendous flexibility. It may be adapted, for example, to handle a wide variety of classes of dental products, such as term life insurance, permanent life insurance, combinations of term and permanent life insurance, health insurances, disability insurances, long term care insurances, and the like. The processor module can accommodate any type of patient information that can be incorporated into the patient database. In addition, the processor module has great flexibility in the specific analytical and decision making methods and procedures used. Specific yet merely illustrative examples are provided below.

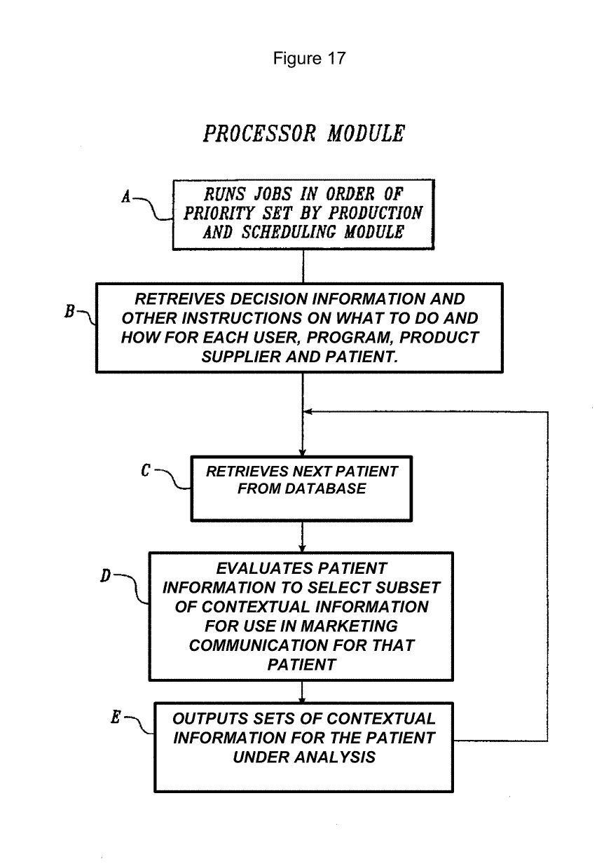

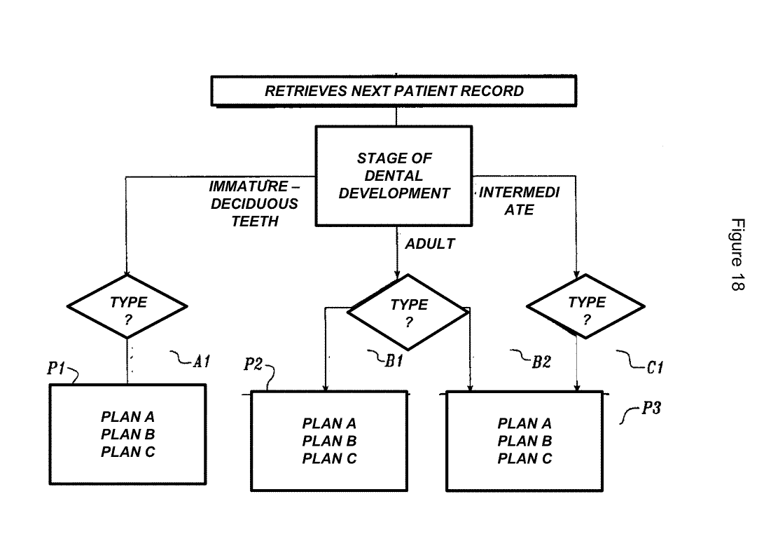

A flow chart depicting the general organization and logic flow of the processor module for the preferred embodiment and method is presented in FIG. 17. As indicated at block A, the processor module is scheduled by and operates under the general instruction of the production and scheduling module (described more fully below). The production and scheduling module would determine, for example, which of several competing jobs or for example patient databases would be processed and in which order. The processor module flow then moves to step B, in which it retrieves decision information and other instructions delineating the tasks the system is to perform and upon which information.

The processor module flow at block C retrieves the information, in this case a patient record (patient information), which is to be used with the decision information in selecting the contextual portion information. By operating upon the decision information, such as database query commands based upon the patient database fields, the system processes the patient information and uses it to select the contextual portion information. The type of information retrieved by the processor module will depend upon the type of analysis under consideration, and for which the system has been adapted. Illustrative examples of such input data are described above with reference to the data input module and the database module. The processor module is described herein as processing data files sequentially, one record at a time. This is not necessarily limiting. For example, the processor module may be configured so that it processes more than one record at a time through an approach such as as multi-tasking or parallel processing, and/or by means of networked machines operating in parallel or otherwise concurrently.

In step C, depending on the particular application, the processor module may undertake some pre-sorting or other manipulation of the patient information prior to the principal analysis of it. For example, there may be categories or items of information within a given patient record that are not utilized in the analysis and decision making procedures to be undertaken by the processor module in that application. Therefore, it may be appropriate to modify the retrieved patient records to eliminate such categories or items before further processing in undertaken in the processor module.

In step D of the processor module, the processor module uses the decision information to analyze and evaluate the patient information for that record to select the subset of contextual portion information for that patient. The selected contextual portion information is outputted as step E. This may occur as each patient record is processed or, preferably, for a plurality of records. The process returns to block C to retrieve the next patient record, and processing is repeated at block D. This looping process is continued until all patient records to be processed in fact have been processed in this manner.

A slightly more complicated application or process flow for the processor module of the preferred embodiment and method is illustrated in FIG. 18. In this embodiment, once the processor has retrieved the next patient record, the patient's stage of dental development is identified from the patient information. As can be seen, irrespective of the stage of development, the next step is to identify the type of dental problem to be addressed. At this point, a patient with for example immature dental development would be advised to use one or more plans depending on the nature of the problem. The same occurs for both adult and intermediately mature teeth. Interestingly, in this embodiment, there are two subtypes of actions that can be undertaken for adult teeth, including, B1 which involves a set of plans associated with certain types of problem, and B2 which involves a set of plans associated with another set of problems.

Contextual portion information may be selected using patient information, i.e., the decision information may include using patient information to select the contextual portion information for inclusion in the marketing communication. This is generally true regardless of the nature or content of the information actually selected as the contextual portion information.

As part of the retrieved decision making criteria, the processor module would retrieve the information depicted graphically in FIG. 18.

Dental product information also may be used to select the contextual portion information. To illustrate, a particular dental product may be offered at one price in some states or to one demographic and at another price in others. As part of the decision information, the system and method may use this pricing information to select text and/or pricing information as contextual portion information for inclusion in the respective marketing communications.

The subset or subsets of the contextual portion information selected for a given patient is adapted to be inserted into or provided as an integral part of the corresponding contextual portion or portions of the marketing communication for that patient. Depending upon the manner in which the tasks are segregated, the output of the system software therefore may comprise the completed marketing communications ready as they are delivered to the patients. Short of this, however, the system output may comprise an intermediate product such as the subset or subsets of the contextual portion information themselves, ready for inclusion or integration into the marketing communication or communications, but not yet so integrated or merged.

In the latter instance, i.e., where the system output comprises unintegrated subsets of the contextual portion information themselves, ready for inclusion or integration into the marketing communications, these contextual portion information subsets preferably would be stored and provided as part of the patient information database, e.g., as was provided as part of the initial system and method input, or as a separate database. Each record of the database would include the subset of contextual portion information for that patient, as well as an identifier to identify the patient, such as patient name, account number, etc. This patient output database could be stored, for example, to RAM 28, mass storage 30, or other suitable storage medium.

As an optional but preferred step in the method, the contextual portion information is automatically inserted into the marketing communications. This step preferably involves generating the marketing communication according to the communication presentation, wherein the generating step includes inserting the subset of contextual portion information into the contextual portion of the marketing communication corresponding to the contextual portion of the marketing communication presentation. The contextual portion information preferably is inserted or merged into the presentation or other text of the marketing communication without unwanted gaps or spaces, so that the entire document appears to be created from a single source, or the entire document appears to be an integrated whole. The merged subset or subsets of the contextual portion information may be presented with the same font or a compatible font to achieve this end.

A preferred method includes a step of generating the marketing communications according to the communication presentation. The generating step includes inserting the contextual portion information or a subset of the contextual portion information for a given patient into the contextual portion of the marketing communication for that patient. The preferred embodiment of the invention similarly includes output preparing means in operative communication with the processing means for preparing the marketing communication and automatically inserting the contextual portion information or contextual portion information subset into the marketing communication. In the preferred embodiment, the output preparing means comprises a computer, such as processor 12 and its CPU 26, in conjunction with and operating under the output module. The output preparing means of this embodiment also includes laser printer 32, modem 20, and similar means for creating the final form of the marketing communications, whether they be in the form of printed paper, electronic mail, or other form. Where the marketing communication is to be transmitted on a network or other electronic medium, for example, the output preparing means may comprise another computer.

The output module uses the information obtained from the processor module and optionally from other sources to generate, design, individualize and particularize all of the marketing communications. Marketing solicitations, ads, product- or service-related notices, presentation correspondences, follow-up correspondences, and reminders all would be examples of such marketing communications. The output module automatically prepares and outputs a marketing communication, for example, in a form of a marketing solicitation, which provides information sufficient to enable the patient to make informed, intelligent decision regarding the purchase of the plans or products selected by the processor module, or sufficient to gain the interest of a patient and motivate him or her to seek additional information. The processor module creates these marketing communications in a manner using a presentation which personalizes and individualizes the information presented to the patient.

The output module can selectively use substantial portions of patient information, product information, and in many instances other information as well to generate a particularized communication tailored to the particular patient for whom the communication is to be sent. The communications therefore typically will vary from individual patient to individual patient.

Marketing communication generation according to the preferred embodiment and method involves organizing, presentation and outputting marketing communications using information received generally from the processor module. As explained, the processor module uses patient information, information about available dental products, and perhaps other available information to recommend products, plans, and the like specifically tailored to each patient. The output module allows the system user to define a particularized communication presentation for classes of customers, such as for potential individual mortgage insurance patients. It then generates highly individualized communications specifically tailored to present that patient with individualized plan and product presentations, reminders, follow up, etc.

The output module is adapted to present its output in a variety of forms. For example, the output can be displayed on display 14 for visual inspection by the system user, or patient, etc. The output also may be in the form of a printed communication or document using a printer such as a laser printer. It may be in the form of an automated document or data file or both, and it also may be in a form suitable for transmission, for example, over modem 20 or to a network, with or without simultaneous video conferencing and for transmission via the internet.

The particular presentation of marketing communication outputs will depend upon the specific circumstances, such as patient demographics, plans and products offered, and marketing objectives of the particular application.

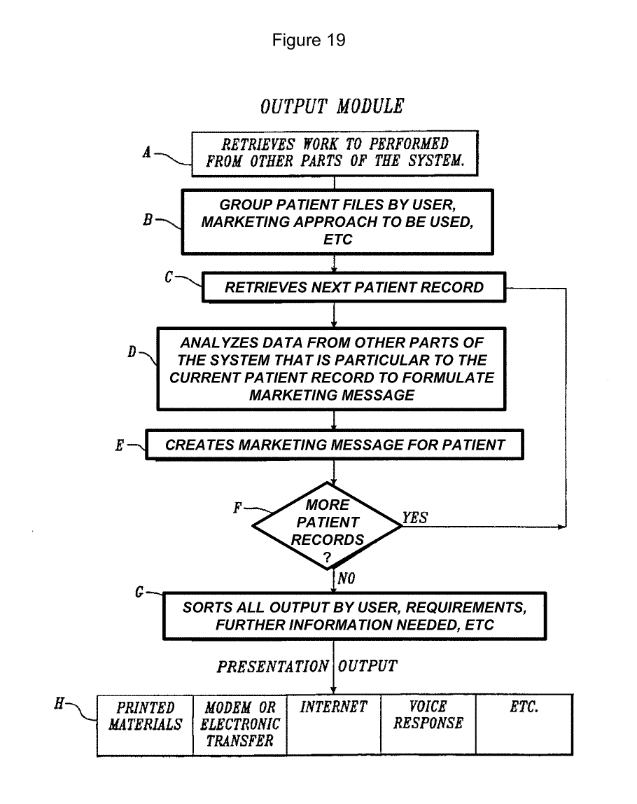

FIG. 19 presents an illustrative flow chart diagram of the logic flow of the output module for a preferred embodiment and a preferred method. In step A of FIG. 19, the output module retrieves work to be performed from other parts of the system. For example, after a set of patient records has been processed with the processor module as described above, the output module would retrieve those files and store them in temporary memory locations so that a marketing communication, for example, can be prepared for each patient record. As part of step A, the output module retrieves instructions which would be used in preparing the marketing communication or other communications output. The specific nature and content of these instructions will depend upon the specific type of marketing communication to be prepared and the specific presentation for the marketing communication. The specific examples to be presented below also provide a description and explanation of the types of the instructions used by the output module in preparing communications.

In step B of FIG. 19, patient files are grouped by user, or by the sales program to be used, or by other criteria specified by the system user. Grouping criteria preferably would be selected by the system user during a setup phase, and would remain unchanged indefinitely until a different set of grouping criteria is desired.

The processing of a set of patient records to generate and output a corresponding set of marketing communications primarily takes place between step C and F of FIG. 19. More specifically in step C the output module receives a patient record for processing. In step D, the output module analyzes and evaluates the patient information from the patient record, the corresponding output from the processor module for that patient record, and other data or information needed to construct the communication. Other forms of data or information which might be retrieved at this point could include geo-coding data, demographic data, and the like.

In step E, the output module uses the instructions for preparation of the communication, together with the data and information from step D, to prepare the marketing communication. The specific manner in which the instructions and the information are used to construct the communication will vary depending upon the application, the specification of the system user and other factors.

The output module may include any one or any combination of at least four types of logic or contextual portions, including (1) customer information logic, (2) words/paragraphs/sentence (“text”) logic, (3) product/plan/amount of coverage/payment mode/underwriting logic, and (4) pricing logic. “Logic” or “contextual portion” as referred to herein may involve the placement of a particular word, number, phase, or item of information in a particular place within the communication. Insertion of such items within a blank space in a sentence would be an example. Patient information logic refers to the place of the selective placement of patient information in a particular location, blank space, or gap in a communication. “Text logic” refers to the insertion of Words, Paragraphs, Sentence etc. other than patient information, product type and related information and pricing information, which is selectively placed in a specific location, blank space or gap in the communication. Products/Plans/Amount of Coverage/Payment Mode/Underwriting Logic (“product logic”) refers to information pertaining to any of these topics, which is to be placed in particular location, blank space or gap in the communication. Pricing logic refers to pricing information which pertains to the product which is to be positioned in a particular location, blank space or gap (contextual portion) in the document.

Through designation by the system user in interaction with the system, the output module creates the presentation to be used, the specific information to be included within the presentation, and the specific locations in the output presentation where the specific items of information will be used. It also presents all sections to be easy to read and highly organized, no matter what amount of information is contained in the output.

The method according to the invention also may and preferably does include a step of automatically combining the marketing communication with the primary communication to create a combined communication, wherein the combined communication comprises a single document, again using the term document in its broad sense. Where a plurality of marketing communications are to be prepared, this step includes automatically combining the marketing communication for each of the patients with the primary communication for the corresponding and respective one of the patients to create a combined communication for the corresponding and respective one of the patients, wherein each of the combined communications comprises a single document.

In accordance with one method, all marketing communications sent to the patient could be accompanied by an offer of a dental product, together with a clickable link to facilitate reply. This effectively results in a one-step sales process for any or all sales programs and products marketed by the system. In many instances, little or no human interaction or involvement is required in the marketing and purchasing process beyond the initiation of the system to provide the appropriate input information.

Turning now to the administration system as illustrated in FIG. 14, the various modules of this system are intended to provide support functions for the Base system modules. In addition, they include management and administrative support modules to aid management in the system, including operation of the base system, scheduling of follow-ups, future communications, etc., with little or no need for human involvement.

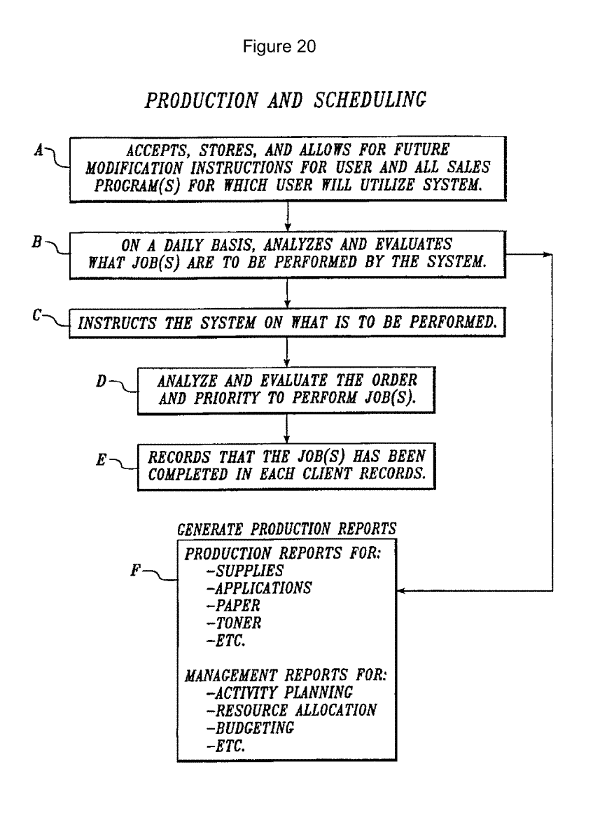

The production and scheduling module automates scheduling of marketing sales, preparing budgets, and the like. A flow diagram outlining the logical organization and flow of the production and scheduling module according to the preferred embodiment and method is shown in FIG. 20. In step A of FIG. 20, the production and scheduling module accepts, stores and allows for future modification instructions for system user(s), and for all sales programs for which the system user will utilize the system. Future add-on sales programs can be easily accepted.

As shown in step B of FIG. 20, the production and scheduling module analyzes and evaluates the jobs which are to be performed by the system. This is done on a daily basis. With this information as an input, the production and scheduling module schedules operation of the base system and instructs the system to operate accordingly, as indicated in step C. In the course of this scheduling and the instruction, the production and scheduling module operates according to a set of predetermined criteria to determine the ordering and scheduling of the system operation and job performance.

As jobs are completed, the production and scheduling module causes that fact and others to be recorded in each of the patient records for which processing has been successfully completed. This is indicated in step E of FIG. 20.

As an administrative support role, the production and scheduling module is capable of generating hard copy, readable, production reports, e.g., on a daily basis, as indicated in step F. of FIG. 20. Production reports may be useful for system users and operators, for example, for allocating and providing sufficient supplies, paper, toner, etc. The system also is capable of generating management reports which can aid management in activity planning, resource allocation, budgeting, etc.

The production and scheduling module also is useful for automatically following up on pre-defined activities. A useful attribute of the production and scheduling module is it's ability to remember a virtually unlimited number of users and user sales program(s) and implement a virtually unlimited number of instructions for the system to begin work at any point in the future.

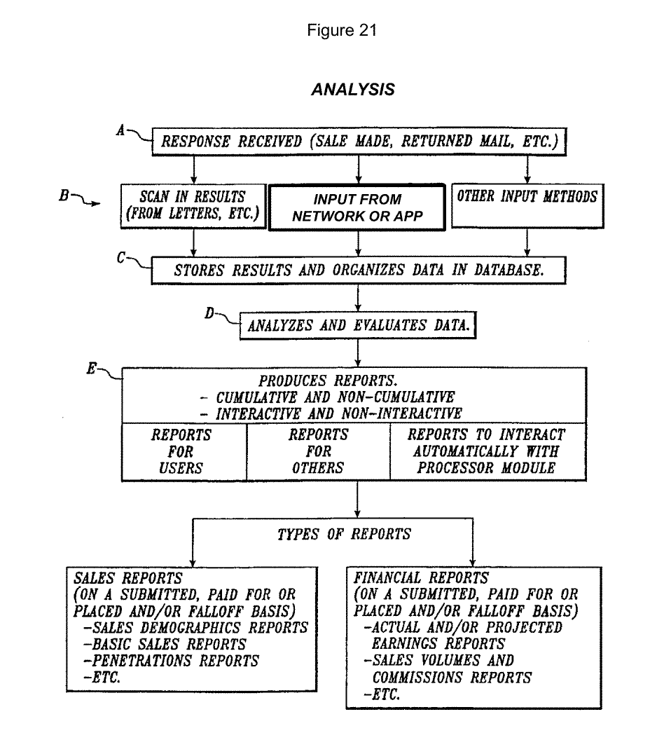

Analysis module assembles, calculates and outputs sales, test, dental and projected earnings reports. This can be done on a real-time basis with the preferred embodiment and method. A flow chart which illustrates the organization and flow of the analysis module for the preferred embodiment and method is shown in FIG. 21. As shown in that illustrative diagram, step A involves receiving sales information based on sales of dental products actually made. In step B, these sales results are inputted into the system, manually, by scanning, or by other methods described above which regard to the data input module. In step C of FIG. 21, these results are stored and organized in a sales database resident in the database module. The sales report module analyzes and evaluates this sales data, e.g., by segregating and compiling it in presentations and statistical summaries useful in management.

Once calculated, compiled, etc., the data may be incorporated into and reported as sales reports, as reflected in step E of FIG. 21. These reports may be cumulative in nature or they may be non-cumulative, essentially reflecting snapshots in time. The reports also may be interactive or non-interactive, depending on the presentation selected, the output mode, etc. The reports may be provided to system users, management, etc. These reports also may be used in digital or automated form to interact automatically with other modules of the system, for example, the processor module.

The sales reports may compile such information as sales demographics, penetration, etc. They may reflect such statistics on several basics, such as sales submitted, the number of sales actually placed, based on type of products or services, etc. The sales module also is adapted to generate financial reports. These financial reports also may reflect sales on a submitted, placed, and or falloff basis. They may be incorporated with other data to reflect actual and/or projected earnings reports, commission reports, and the like.

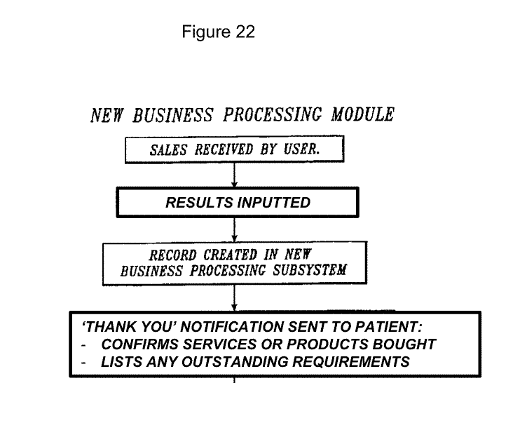

The automated new business (“new business”) module supports the processing for new business. The automated portion of this module supports the future policy holder service and insurance need of the patient automatically. Flow chart reflecting the organization and logic of this module is shown in FIG. 22. Referring to FIG. 22, as sales are made the sales information is received by the system user. The sale results are inputted, for example, automatically by the software, or by scanning, or by other input means, e.g., as disclosed in the discussion of the data input module. As new sales are made a corresponding patient record is created in this module. The module automatically creates a “thank you” notification, which is customised for that particular patient. It confirms the products that have been purchased and the corresponding coverage. The automatically-generated communications also lists any outstanding requirements the patient needs to execute to obtain product.

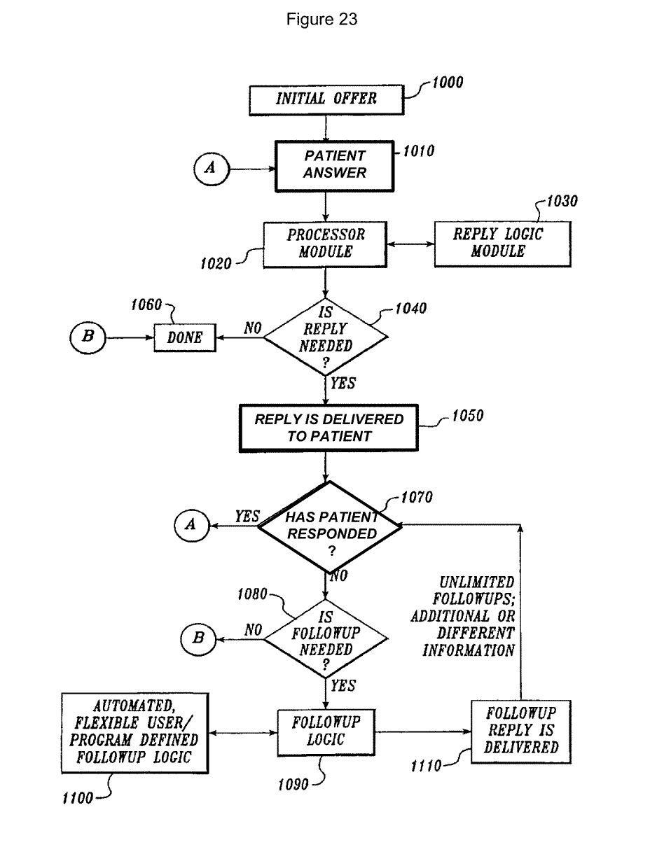

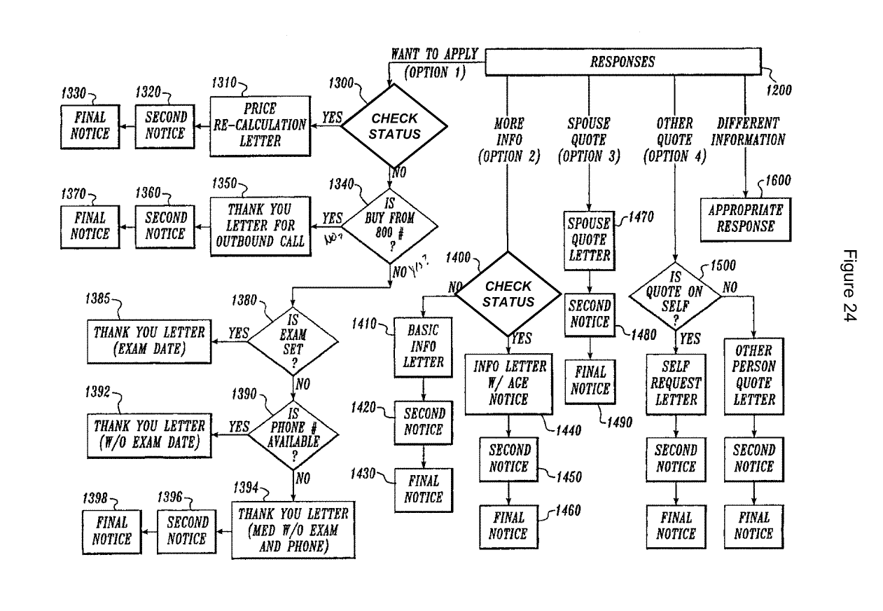

FIG. 23 sets out a further implementation of an embodiment of the invention. In this particular non-limiting illustrative embodiment, an initial mass communication is mailed to a plurality of patients (up to tens or hundreds of thousands, or even millions) in step 1000. The mass communication elicits patient answers 1010, and these are electronically read into a logic system 1020. The logic system 1020 reviews the patient answer, analyzes the answer 1030 and then determines whether a reply correspondence must be generated 1040. For example, if the patient answer relates to a solicitation for a dental product or service, in which several different options were presented, and the patient requests further information on either one of the options, or requests an additional quotation, then the system logic 1020 and 1030 recognizes the patient answer. If the patient requires an additional quotation, for example, an additional correspondence to the patient will be needed. If no communication is needed, for example if the patient has made a “purchase answer”, then the answer is routed out of the system to step 1060 where the purchase is further processed and a “thank you” correspondence or additional follow up is generated, as needed. On the other hand, if it is determined from the answer that the patient requires additional information, an appropriate correspondence is generated addressing the specific patient's requirements. This correspondence is then delivered to the patient 1050, by any one of a variety of means, which could be specified by the patient. The system can process answers and automatically (preferably electronically) generates a plurality (thousands, hundreds of thousands, or millions) of replies, each directed specifically to an answer from a particular patient.

Once the first reply has been delivered, it might be expected a patient would further respond by either making a purchase, or continuing to make further inquiries. The system of the invention provides the advantage of permitting a continuing “conversation” with the patient, by providing continuing follow-up replies to each answer received from a patient, until the patient either makes a purchase, or fails to respond. In the latter instance, follow-up communications may be sent to determine why the patient has ceased responding, and to encourage further communication until a purchase decision is made.

Referring back to FIG. 23, the system tests whether a patient has responded to a prior delivered reply in 1070. If the patient has responded, the patient answer is again input and analyzed as discussed above. If the patient has not responded, a determination is made as to whether a follow-up is needed 1080. If a follow-up is not required, the communication with the particular patient is terminated. On the other hand, if a follow-up is required, the communication is processed through follow-up logic 1090 which generates a follow-up correspondence that is delivered 1110 to the patient by any one of a variety of appropriate means. Once the follow-up correspondence is delivered, the system retains information in memory, and tests at a later date whether the patient has responded 1070. If there has been no answer, the system determines whether a follow-up is needed 1080.

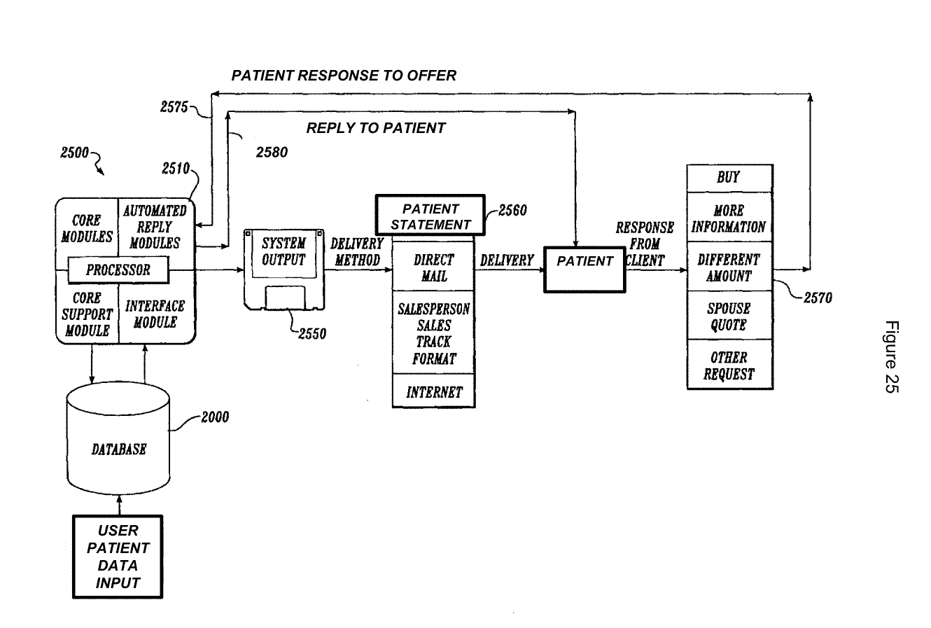

FIG. 24 is a non-limiting illustrative example of a system of the invention for generating replies. As a preliminary matter, a mass communication will have been made to patients regarding the offered dental product or service, whether through appending a communication regarding the offer to a primary communication, or simply by delivery of a customised (or generic) offer of dental products or services (that may include several options suitable for the individual patient) by any one of several appropriate delivery means. The original communication will have provided patients with several (or unlimited) options for answer, for example, the range of answers may include “purchase (apply)”, “need more information”, “need more information on option x”, “need additional quotation for (spouse, child, etc.)”, and any other of a myriad of possible appropriate answers selected by the party initiating the mass communication (in this case the user, dental practitioner, etc.).

The answers to the mass communication are then input automatically, such as by electronic transmission or scanning, into the automated system of the invention. The embodiment illustrated in FIG. 24 shows discrimination between four types of standard answers, and also a handling mechanism for requests for “different information”. Clearly, the system can readily be adapted for handling many more or fewer answer options. Continuing with the example of FIG. 24, once the answers are sorted in step 1200 those answers relating to option 1 (“purchase option”) are further analyzed to determine whether the patient's dental health status corresponds to the assumed status in the original communication 1300. If there is correspondence for dental health check purposes, a notification is sent to the patient after further checking, as discussed below. If, on the other hand, there is a discrepancy between the originally assumed dental health of the patient and actual dental health as disclosed in the answer, the system prepares a “price recalculation correspondence” 1310, which is delivered to the patient. Thereafter, at a predetermined interval, a “second notice” is generated 1320 and sent to the patient. If a purchase answer is not timely received, in order to capitalize on the patient's desire for dental products or services and to avoid loss of patient interest. If there is no answer to the second notice, then after a predetermined time a “final notice” is generated 1330 and sent to the patient.

If, as discussed above, the patient's dental health status matches the originally assumed status, the system checks 1340 whether the patient has indicated a desire to buy through a “1-800” number. If not, a “thank you correspondence” is generated 1350, followed-up after a preset time period by a second notice 1360 and thereafter a final notice 1370, as discussed above. On the other hand, if purchase is through the “1-800” number, the system checks whether a physical examination date has been set 1380. If so, a “thank you correspondence” specifying the exam date 1385 is sent to the patient. If the date is not set, the system checks whether a phone number is available 1390. If a phone number is available, the patient is telephoned and an examination date is confirmed. A “thank you correspondence” is then generated and sent to the patient with the examination date. On the other hand, if a phone number is not available, a “thank you correspondence” is generated 1394 that does not specify the examination date and that requests a call back or answer to set the examination date (i.e., indicating a need for communication to set an examination date). Thereafter, the system follows-up with a second notice 1396 and, if necessary, a final notice 1398 at predetermined intervals as follow-up to encourage and facilitate the patient's desire to continue the process for obtaining the dental products or services.

If the system determines in block 1200 that the patient answer requests “more information”, the answer may be directed to a first system check for patient “check status” 1400. Thus, if a patient has an indicator of sub optimal dental health (for example via one or more common risk factors such as age, diet, smoking status, etc), the system will generate a basic information correspondence 1410, and will retain in memory a time to check for answer to that basic information correspondence. If an answer is not received within a predetermined time, a second notice 1420 is sent out, which may be followed-up by a final notice, if necessary and appropriate. On the other hand, if the patient has clear indicators of good dental health, a different information correspondence is generated by the system 1440. That information correspondence takes into account factors relating to the patient dental health, as well as other pertinent information supplied or otherwise available. As indicated before, a virtually unlimited number of replies can be sent (based on most demographics) and based on the (almost unlimited) answer options. This information correspondence may also be followed-up by a second notice 1450 at a preselected interval, if no answer is received for the information correspondence. A further final notice 1460 may be generated by the system when there is no answer to the second notice correspondence after a predetermined interval.

When the system determines that the patient has selected an alternative answer, one that, for example, requests information in relation to a dental product or service for a child or spouse, information regarding the spouse or child is automatically input into the system, and, for example, a “spouse quote correspondence” is generated 1470. As with other correspondences requiring answers from the patient, follow-up correspondences are generated at predetermined intervals, a “second notice” 1480, followed up by a “final notice” 1490 if necessary and appropriate.

In the event that the patient has selected another option, requiring for example further quotations “dental product or information for him or herself” or someone else this is determined automatically in the system 1500. In answer, a “self requote” correspondence is sent, appropriately followed-up by a second notice 1520 and final notice 1530, as discussed above. On the other hand, if the quote is not for the patient him/herself, the system reviews data supplied for the other person for whom the insurance quote is required, and generates a “other person correspondence” 1540. This is appropriately followed-up with a second notice and final notice correspondence, as discussed above.

The system may also include the flexibility to handle the answers that require additional information, other than standard option answers provided in the original communication, or in any subsequent reply communication to the patient. This request for “different information” is segregated and an appropriate reply is prepared 1600. For example, the patient answer may be to call in and a reply would be generated when or shortly after the call is answered, either by a person, or by voice recognition and answer technology.

Answers through the internet may be accumulated with the data transferred at intervals to the reply generation system of the invention. In the illustration of FIG. 25, the internet answer 1850 is transferred in real time to the system 1900 which automatically generates an appropriate reply that responds to the patient answer, preferably also delivered through the internet to the patient. Accordingly, the internet related system potentially provides the fastest answer, and may be expected to enhance the conversion of solicitations of insurance (or other product) to sales.

A summary and overview of an embodiment of the system of the invention is shown in FIG. 25, this overview and summary is for illustrative purposes only, and clearly does not limit the scope of the invention which may include many additional and different aspects, depending upon the application to which the system is adapted.

As shown, the system software 2500 accesses a database 2000 that contains relevant information regarding patients, that may be maintained by a dental products supply company, a chemist, a dental practitioner, an orthodontist, a doctor, a dental hygienist, or any other entity that has a patient database. As a preliminary matter, the system of the invention accesses the database and prepares individualized marketing communications to each of the multitude of patients (or subset of the multitude of patients) in the database. The system software 2500 generates an output 2550 that may be delivered to each individual patient by any one of several methods 2560. In the example shown, communication may be sent to a patient on a monthly statement, by direct mail, through platform sales tract presentation, or through the internet. The communication includes answer options 2570, and the patient answers indicating a selected option, of which several non-limiting examples are shown in FIG. 25. The patient answer 2575 is input into the system of the invention, and the reply module 2510 of the system software 2500 generates a reply 2580 for each answer, out of the multitude of answers. The reply is preferably sent directly to the patient through an indicated delivery method, which may include direct mail, facsimile, internet, voice telephony, and the like. The reply may generate further patient answers, so that an ongoing “conversation” is set up between the patient and the automated reply module 2510 of the system of the invention. This conversation continues, as explained above, until it is terminated by either a patient “purchase decision”, or lack of patient answer to a communication from the system.

A person skilled in the art will appreciate that many embodiments and variations can be made without departing from the ambit of the present invention.

In compliance with the statute, the invention has been described in language more or less specific to structural or methodical features. It is to be understood that the invention is not limited to specific features shown or described since the means herein described comprises preferred forms of putting the invention into effect.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

1. A method for determining suitability of an orthodontic treatment, the method comprising the following steps performed by at least one computational device:
posing one or more queries relating to a potential patient;
receiving one or more answers to the queries; and
determining the suitability of the orthodontic treatment based upon the received answers.

2. An orthodontic treatment suitability system including at least one computational device and configured to:
pose one or more queries relating to a potential patient;
receive one or more answers to the queries; and
determine suitability of an orthodontic treatment based upon the received answers.

3. A method for tracking the progress of a patient undergoing orthodontic treatment, the method comprising the following steps performed by at least one computational device:
capturing images of the patient's teeth over time; and
sequentially displaying the images showing any change in the patient's teeth.

4. A method for motivating a patient undergoing orthodontic treatment, the method comprising the following steps performed by at least one computational device:
providing or determining a duration until an event associated with the patient; and
providing a countdown until the event.

5. A computerized method of generating a marketing communication for a dental health patient, the method using a computer system comprising the steps of:
successively generating a communication for each of a plurality of persons, the communications each comprising identifying content to distinguish each person from other persons of the plurality of persons, and customised content relating to an offer to each person,
wherein the generating a communication includes accessing a computer-accessible storage medium to determine at least part of the customised content relating to the offer from at least one set of information associated with the offer.

6. A method according to claim 5 wherein at least one customised content generated for a first person's communication is different from a second customised content generated for a second person's communication.

7. An apparatus for generating a marketing communication for a dental patient, the apparatus comprising:
a computing system; a computer-accessible storage medium coupled to the computing system;
computer software executing on the computing system and adapted to automatically cause the computing system:
to successively generate a communication for each of a plurality of persons, the communications each comprising identifying content to distinguish each person from other persons of the plurality of persons, and customised content relating to an offer to each person,
wherein the generating a communication includes accessing the storage medium to determine at least part of the customised content relating to the offer from at least one set of information associated with the offer.

8. An apparatus according to claim 7 wherein at least one customised content prepared for a first person's communication is different from a second customised content prepared for a second person's communication.
